(19) United States
(12) Patent Application Publication
(10) Pub. No.: US 2004/0084043 A1
(43) Pub. Date: May 6, 2004

(54) Method and fracturable tile for making tesserae and listels

(76) Inventors: Giorgio Mingarelli, Modena (IT); Andrea Mattioli, Sassulo (IT); Cristiana Vandelli, Sassulo (IT)

Correspondence Address: WILLIAM J. SAPONE, COLEMAN SUDOL SAPONE P.C., 714 COLORADO AVENUE, BRIDGE PORT, CT, 06605, US

(21) Appl. No.: 10/332,152

(22) PCT Filed: Jun. 27, 2001
(86) PCT No.: PCT/IB01/01145

(30) Foreign Application Priority Data
Jul. 6, 2000 (IT) BO2000A 000399

(51) Int. Cl. B28D 1/32

(52) U.S. Cl. 125/23.01

(57) ABSTRACT

A fracturable tile for making tesserae or fillets has on the fixing face a pre-fracture regular grid (14) consisting in two series of parallel and equally spaced pre-fracture lines (2) which extend from an edge to the opposed one of the tile and each of these latter includes first grooves (10). The pre-fracture grid (14) delimits portions (3, 4, 5) of the tile in order to allow its split in tesserae or listels.

### TECHNICAL FIELD

The present invention refers to the manufacturing of the covering or flooring materials used in the building trade.

Particularly the invention refers to a method and fracturable tile for making tesserae or listels. Both the tile and the tessaras/listels are provided for covering and/or tiling floors or their decoration, building surfaces and architectural elements.

### BACKGROUND OF THE INVENTION

They are known tesserae or little tiles carried out by cutting through all the thickness of slabs or tiles of bigger dimensions,

The main drawback of these known tesserae or small tiles consists in that they have precise and regular edges, which are not suitable for the handicraft coverings, floorings and decorations. In fact the regularity of the tessaras carried out using these methods is typical of the industrial products.

Document DE 296 04 624 discloses a device to fracture tiles.

Furthermore, there are known tesserae or little tiles carried out from tiles or slabs in which deep grooves are made starting from the fixing face, as disclosed in document EP 0 894 593. The split of the tiles or slabs in tessera or little tiles is manually made by operators exerting such strengths to fracture the tiles along the scored lines. The resulting fractured edges are irregular and sharp. A further processing phase allows the chamfering of the fractured edges.

This known method allows giving the tesserae or tiles an irregular aspect but has the main drawback of providing an expensive manual-processing phase dangerous for the operators.

A further drawback of this known method is the long processing time that strongly limits the productive capacity.

Another type of tessaras is carried out by making deep grooves starting from the assembly face of slabs or tiles and then making on the groove bottom thinner cuts which split the plate in tesserae; consequently the cut sides of the tesserae have a thin rim in correspondence of the quarry face. This thin rim is then splinted and made irregular by a tumbling phase. Then the main drawback of these known tesserae consists in that the irregularities are positioned along substantially rectilinear edges.

The main object of the present invention is to propose a flooring or covering tile which can be fractured in tessaras or listels having irregular edges, moderately curved and with handicraft aspect.

Another object is to propose a fracturable tile fit for making tessara/listels having at least a rectilinear regular edge suitable for connecting other coverings or floors or for making the peripheral covering/flooring portions and having the irregular remaining edges.

A further object is to propose a mechanical-type fracture method for the fracturable tile.

The objects above-mentioned are achieved according with the content of the claims.

### BRIEF DESCRIPTION OF THE DRAWINGS

The characteristics of the invention are underlined in the following with particular reference with the attached drawings, in which:

FIG. 1 shows a partial plan view of the assembly face of the tile object of the present invention;

FIG. 2A shows a partial section view of the tile of FIG. 1 in an approaching condition of the fracturing means immediately before operating these latter;

FIG. 2B shows a partial section view of the tile portion of FIG. 2 in a condition immediately following the operation of the fracturing means.

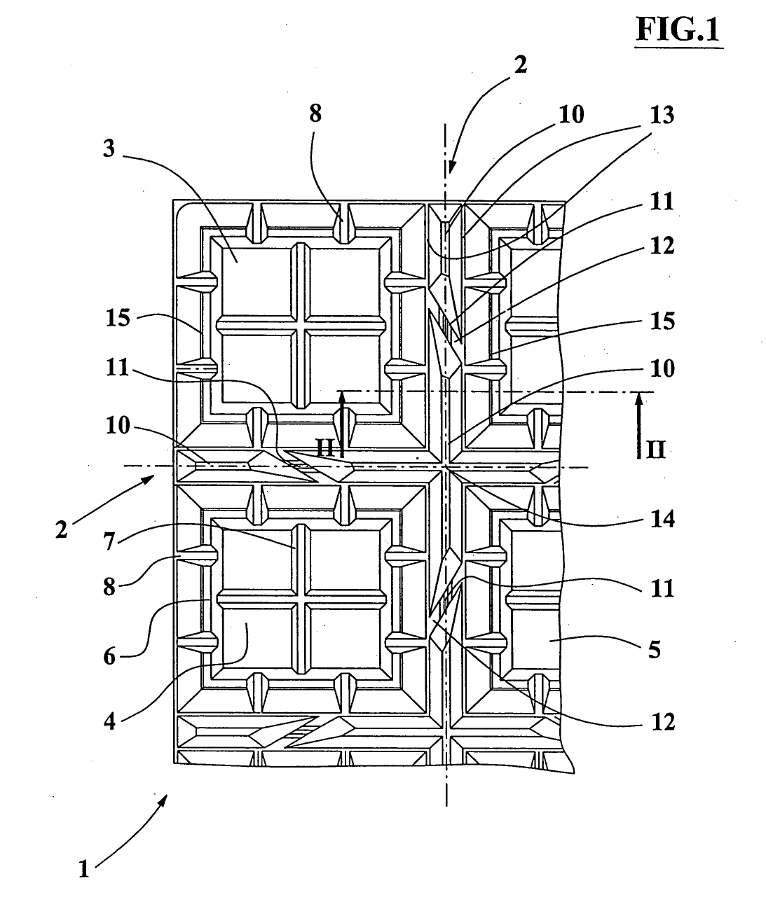

In FIG. 1, the reference 1 indicates a tile, for instance a floor tile or covering tile in ceramics, grés, majolica, porcelain, glass or similar, object of the present invention.

The assembly face of the tile 1 has two series of parallel and equally spaced pre-fracture lines 2 extending from an edge to the opposite one of the tile 1 so forming a regular pre-fracture grid 14.

The pre-fracture grid 14 delimits portions first 3, second 4 and third 5 of the tile that can be split in tesserae respectively with two, three and four irregular sides originated from fractures. Each pre-fracture line 2 consists in a series of aligned and alternate first grooves 10 and second grooves 11. These latter are carried out in correspondence of linking stiffenings 12 between portions of the tile 1 split by the grid 14. The stiffenings 12 are oblique, alternatively at opposite directions, with respect to the pre-fractured lines 2 for increasing the stiffness and to trigger irregularities at the fractures.

The grooves, first 10 and second 11, are sideways delimited by flat stopper 13 forming 10 parallelograms peripherally extending to the portions 3, 4 and 5 of the tile 1, split by the grid 14.

Each portion 3, 4, and 5 has, internally with respect to the stoppers 13, first stiffening ribs 15 broken by a plurality of outlets 8 fit, during the assembly phase, to allow the outflow of the air eventually contained into the mortar or fixing glue between the wall and the tile or tessura. The fixing face of the tile 1 further has cross-shaped ribs 7 for stiffening each portion delimited by the grid 14.

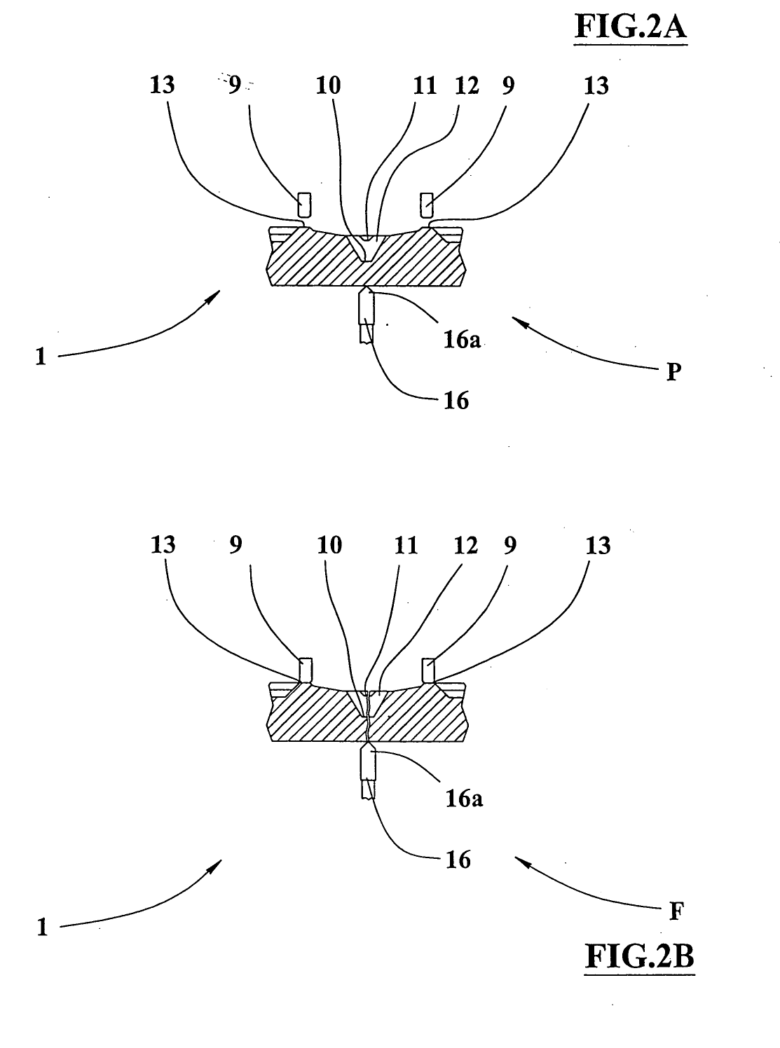

Whit reference to FIGS. 2A and 2B, the tile thickness is the smallest in correspondence of the first grooves 10 and the thickness of the stiffenings 12 is reduced in correspondence of the second grooves 11.

It is also provided that the first grooves 10 extend without gap along the whole length of each pre-fracture line 2.

The split of the portions 3, 4, and 5 for obtaining a plurality of tesserae is achieved by fracturing several times the tile 1 according to the pre-fracture lines 2 of a series so obtaining linear strips of portions 3, 4 and 5 jointed along a side. The following fracture of linear strips of portions 3, 4 and 5 according to the pre-fracture lines 2 of the second series splits the single tesserae.

The fracture of the tile 1 is made according to the method including the following steps of:

positioning a couple of counter punches 9, for instance linear continuous of length equal or longer than the biggest dimension of the tile 1, in correspondence of a couple of stopper 13 related to a pre-fractured line 2, for instance the first one starting from an edge of the tile 1;

positioning a punch 16, for instance linear continuous of length equal or longer than the biggest dimension of the tile 1 and with sharp punching top 16a contacting the tile quarry surface in correspondence of the pre-fracture line 2, delimited by the couple of counter punches 9;

exerting on the tile 1 a perpendicular force of mutual approach between the counter punches 9 and the punch 16 till the fracture of the tile 1;

repeating the fracture for each pre-fracture line 2 parallel to the first one up to the achievement of listel or tessera strips joined at one side only.

At this point, a series of fillets or linear strips of tesserae are obtained.

The method further provides to repeat the fracture for each pre-fracture line 2 of each strip of tesserae up to the achievement of split tesserae, each one with 2 or 3 or 4 edges originated from fractures and therefore irregular.

Furthermore, the method provides to subject the tesserae or the split listels to tumbling and/or sandblasting in order to chamfer the edges of the fractures and/or to give them an old-fashioned appearance.

The main advantage of the present invention is to provide a directly usable tile for floor or covering or fracturable in tesserae with irregular edges, moderately bent with a handicraft aspect.

Another advantage is to provide a fracturable tile suitable to origin tesserae having one, two or any regular rectilinear edge fit for joining other coverings or floors or making the peripheral covering portions and having the remaining edges irregular.

A further advantage is to provide a fast, safe and economic mechanical-type method for fracturing the tiles.

1) Fracturable tile for obtaining tesserae or listels, said tile (1) having on the fixing face a regular pre-fracture grid (14) consisting in two series of parallel and equally spaced pre-fracture lines (2) which extend from an edge to the opposite one of the tile and each of these latter including first grooves (10); the pre-fracture grid (14) delimiting portions (3, 4, 5) of the tile (1) to allow the split of this latter in tesserae or listels; said tile (1) being characterized in that the first grooves (10) are interrupted by a plurality of stiffenings (12) connecting adjacent portions (3, 4, 5) fit to strengthen the tile 1.

2) Tile according to claim 1 characterized in that the first grooves (10) extend without gap along each related pre-fracture line (2).

3) Tile according to claim 1 characterized in that each stiffening (12) has a respective second groove (11) aligned with the relative first groove (10).

4) Tile according to claim 1 or 3 characterized in that the connecting stiffenings (12) between the portions (3, 4, 5) are alternatively slanting positioned with opposed angles with respect to the respective pre-fracture lines (2) for increasing the stiffness of the tile (1) and triggering the irregularities in the fractures.

5) Tile according to any of the preceding claims characterized in that the thickness of the tile (1) in correspondence of the first grooves (10) has the lowest value.

6) Tile according to any of the preceding claims characterized in that each portion (3, 4, 5) delimited by the grid (14) further has first ribs (15) interrupted by a plurality of outlets (8), these latter and the first ribs ( 15) being fit respectively for the air outflow during the assembly and the stiffening of each portion (3, 4, 5).

7) Tile according to claim 6 characterized in that each portion (3, 4, 5) delimited by the grid (14) further has cross-shaped ribs (7) connected to the first ribs (15) and fit for stiffening each portion (3, 4, 5).

8) Method for fracturing a fracturable tile to obtain tesserae or listels, characterized in that provides:
to position a couple of counter punches (9) in correspondence of a couple of stoppers (13) related to-a pre-fracture line (2) of said tile (1);
to position a punch (16) contacting the quarry surface of the tile in correspondence of the pre-fracture line (2) delimited by the couple of counter punches (9);
to apply a mutual approach force, between the counter punches (9) and the punch (16), up to the achievement of the fracture of the tile (1), interposed between them;
to repeat the fracture for each pre-fracture line (2) up to the achievement of fillets or strips of tesserae joined at one side only.

9) Method according to claim 8 characterized in that further repeats the fracture for each pre-fracture line (2) of each strip of tesserae until splitting tesserae each one with 2 or 3 or 4 edges originated from fractures and therefore irregular.

10) Method according to claim 8 or claim 9 characterized in that further tumbles the split tesserae or listels in order to chamfer the fracture edges and/or to obtain an old-fashioned appearance.

11) Method according to claims 8 or 9 or 10 characterized in that further sandblasts the split listels or thesauri in order to confer them an old-fashioned appearance and/or to obtain an old-fashioned appearance.
